(19) United States
(12) Patent Application Publication
(10) Pub. No.: US 2006/0257007 A1
(43) Pub. Date: Nov. 16, 2006

(54) Method and device for analysis of three-dimensional digital image data

(76) Inventors: Ernst Bartsch, Nurnberg (DE); Sultan Haider, Erlangen (DE)

Correspondence Address: SCHIFF HARDIN, LLP;PATENT DEPARTMENT, 6600 SEARS TOWER, CHICAGO, IL, 60606-6473, US

(21) Appl. No.: 11/404,151

(22) Filed: Apr. 14, 2006

(30) Foreign Application Priority Data
Apr. 14, 2005 (DE) 10 2005 017 337.3

(51) Int. Cl. G06K 9/00

(52) U.S. Cl. 382/128; 382/154

(57) ABSTRACT

In a method and device for analysis of three-dimensional digital image datasets, a number of various subjects are merged and are mutually processed multiple times, such that at least one respective significant region associated with a diagnosis method is sought within the image data by means of a number of diagnosis methods of various types that are provided and this at least one significant region is identified and, if applicable, output.

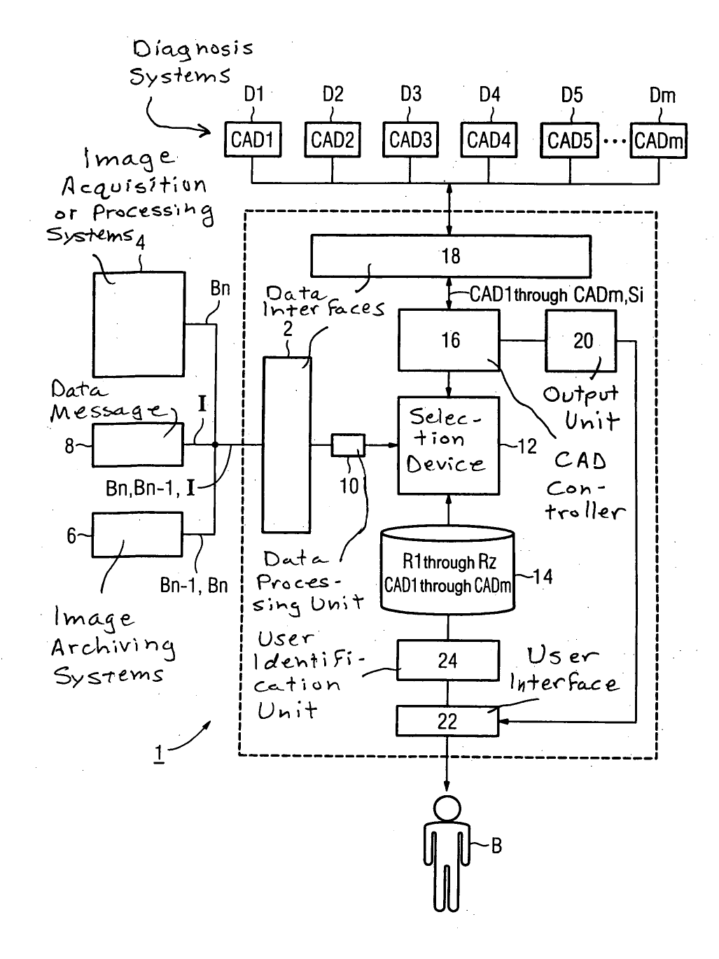

### BACKGROUND OF THE INVENTION

1. Field of the Invention

The present invention concerns a method, in particular a computerized method for analysis of one or multiple three-dimensional digital image datasets, and furthermore concerns a device for implementation of such a method.

2. Description of the Prior Art

Computerized analyses such as computerized diagnoses are important applications in the clinical field. In the present application, the doctor is supported in the examination of, for example, cancers or other illnesses by the acquisition of medical image data and analysis thereof as well as usage thereof for detection of a metastasis. In particular new technologies that enable three-dimensional (3D) scans of the person such as, for example magnetic resonance images (MRI) and computed tomography images (CT) offer enormous possibilities for an improved acquisition of image data and their usage for detection of metastases.

Due to the large data quantity associated with these image acquisition methods, the processing ensues for a clinical picture (disease pattern) typically predetermined by the doctor. Further clinical pictures associated with this predetermined clinical picture possibly remain unconsidered. For this purpose, the image data are respectively separately acquired for the respective clinical picture. Given a complex clinical picture with a number of occurring symptoms, for various diseases multiple examinations (in particular a multiple scan of the person) is thus frequently necessary.

Moreover, the reproduction of the image data that correspond to the normal and the abnormal structure is complex due to the complicated anatomical structures, such that a delimitation of the abnormal structure ensues by marking for the predetermined clinical picture. Various CAD systems (CAD=computer aided diagnosis) are known for this purpose that identify (using associated CAD algorithms) those structures or subjects in the image data that are characteristic for the predetermined clinical picture. For example, CAD systems for lung cancer detection, CAD systems for breast cancer detection, CAD systems for colon cancer detection and/or CAD systems for liver cancer detection are known.

### SUMMARY OF THE INVENTION

An object of the present invention is to provide a method for analysis of one or multiple three-dimensional digital image datasets in which image data of a number of image acquisition systems and/or a number of image subjects can be quickly and simply processed. Moreover, a particularly suitable device is specified for implementation of the method.

In the inventive method for analysis of the image data, the above object is achieved by the image data of various subjects being merged and mutually processed multiple times such that, within the image data, at least one significant region associated with a respective diagnosis method is searched for by a number of predetermined diagnosis methods of various types, and this region is identified and, if applicable, output.

The invention thereby proceeds from the need for an analysis of a large quantity of image data containing image data for various subjects (such as, for example, the head, the lower part of the body and/or the upper part of the body of a person) to be executed optimally quickly and simply. For this purpose, the image data or image datasets are merged for an analysis of all subjects. Since only one specific analysis (diagnosis) is to be considered for one specific subject (for example the head, the torso or for parts of the torso), one appertaining diagnosis. method is selected and activated from a number of diagnosis methods. This diagnosis method in turn processes the image data and identifies the associated significant regions and, if applicable, outputs these. Beginning with the selected diagnosis method, a sequence of diagnosis methods is subsequently started using rules. Using a diagnosis method, in particular a computerized diagnosis method for detection of cancers, whereby the verification of the cancer by the doctor subsequently ensues. The diagnosis method is generally a CAD algorithm. A sequence of diagnosis methods of various types for processing the image data enables a fast and certain identification of significant regions of a number of different clinical pictures. In particular given an application of the method for detection of cancers, it is possible given a widely-progressed and scattered (metastasized) cancer (for example breast cancer or skin cancer) to also already identify and to output other cancers (for example colorectal cancer or bone cancer) in the early stage.

Several diagnosis methods of various types are appropriately provided. For example, various diagnosis methods for detection of breast, colorectal, liver, bone, skin and/or lung cancer are provided as diagnosis methods. Additionally or alternatively, an associated chronological sequence and/or a combination for execution of the diagnosis methods of various types can be predetermined. For example, given an already-identified skin cancer, that method (for example the diagnosis method for detection of bone cancer) can be provided as a subsequent CAD algorithm which is connected with the already activated and/or executed CAD algorithm for detection of the skin cancer. The sequence, series and/or combination of the diagnosis methods is thereby determined by the probability of the successive and/or simultaneous occurrence of altered image data for the appertaining cancer types. This probability is stored using rules using which the sequence, the order and/or the combination of the diagnosis methods are or, respectively, is automatically determined and executed. Alternatively or additionally, the sequence, the order and/or the combination of the diagnosis methods to be executed can be predetermined by the determined variation and/or the determined size (in particular the dimension) of image data subjects. For example, the type and/or the state of the growth of cancer cells which are represented by the image data are taken into account.

At least one further predetermined diagnosis method is appropriately started given an identified first significant region of a first predetermined diagnosis method, by means of which further predetermined diagnosis method at least one further region adjacent to the first significant region is sought within the image data, and this further significant region is output upon identification and, if applicable, marked. One or more further predetermined diagnosis methods for repeated processing of the image data are advantageously, automatically activated and/or deactivated using the first predetermined diagnosis method and/or a predetermined sequence of diagnosis methods. For example, given a first examination of a patient the order and/or combination of the CAD algorithms to be executed is thus automatically determined via the results of the respective CAD algorithm already executed. Only the first CAD algorithm or, respectively, the sequence of CAD algorithms to be executed is predetermined.

In a further embodiment, one or more current diagnosis methods (in particular a sequence of diagnosis methods) are activated or deactivated using preceding and already-executed diagnosis methods. For example, given an already-examined patient this enables a diagnosis method to be restarted using preceding examination results and enables the already-preceding image data to be used for determination of the current diagnosis methods to be executed and their order.

Alternatively or additionally, one or more predetermined diagnosis methods for repeated processing of the image data can be automatically activated and/or deactivated using data representing the significant region and/or regions. Given an already-predetermined number and/or order of diagnosis methods to be executed, the sequence, the number, the order and/or the combination of the subsequent diagnosis methods are changed in a new significant region identified in an intermediate result or, respectively, already-executed diagnosis methods are repeatedly activated and run.

In a further embodiment, data representing the region or, regions are used as input data for activation of the or further predetermined diagnosis methods. For example, given a cancer known to be scattered dispersed (for example skin cancer), the diagnosis method for bone cancer detection is automatically activated and executed using its identified growth stage and/or size. The dimension, the volume and/or the growth stage of the skin cancer are provided as input data, such that the activated subsequent diagnosis method can be correspondingly controlled.

Alternatively or additionally, the further predetermined diagnosis method or methods (in particular one or more sequences) can be manually activated or deactivated. This enables an integration of the examining doctor who determines the sequence, the number, the combination and/or the order of the diagnosis methods to be executed using the first identified and output image data.

The predetermined diagnosis methods of one or more sequences are appropriately executed in parallel or serially in terms of chronology. The results are available particularly quickly given a simultaneous execution of all activated diagnosis methods, and all possible significant data or, respectively, regions (in particular image regions representing one or more cancer types) are available.

In a further embodiment, the identified significant region of one of the diagnosis methods is segmented and measured and, if applicable, output. On the part of the user, the size, the contour and the position of the significant region can be determined and assessed using the selected and segmented region. The variation of the significant region can also be drawn upon for further analyses. Depending on the requirements, the data resulting from the significant region (such as the size, the position, the contour, the volume and/or the center of mass of the region) are supplied to a manual and/or an automatic evaluation. These data also can be used for repeated activation of the already-run diagnosis method with changed control variables (for example a higher resolution) and/or for activation and/or deactivation of further diagnosis methods.

For a concise display of the significant region, this is output emphasized, in particular marked, colored and/or enlarged. The significant region (and/or regions) is thereby advantageously examined for an image subject that is situated within the respective region. For the image subject identified within the region, its size, its volume, its geometric arrangement, its shape, its contour and/or its center of mass is determined for a further specified analysis. This enables a user of the method to quickly and certainly identify the relevant subjects or variations in the significant region and to use these for a diagnosis.

The above object also is achieved in accordance with the invention by a device for analysis of a number of three-dimensional digital image data, having at least one data interface for acquisition of one or more image datasets of various image processing systems and at least one data processing unit for merging the acquired image data of various subjects. A selection device is provided for selection, combination and/or control of a number of predetermined diagnosis methods of various types, in particular at least one sequence of diagnosis methods for a mutual and multiple processing of the merged data. At least one significant region is sought within the image data by means of a selected and activated diagnosis method and this at least one significant region is identified and, if applicable, output.

For example, image data or at least one image dataset of a computed tomography (CT apparatus), or of a positron emission tomography (PET) apparatus or of an MR tomography apparatus for various subjects are acquired by means of the interface. The subjects can be sub-regions of a body and/or an entire body (multi-dimensional whole-body imaging). The image data are supplied to the data processing unit for preparation and merging of the image data, for example merging of the image data from the head, from the leg and/or from the torso into image data of a whole body. The selection device allows the selection and combination of, for example, diagnosis methods of various types (which diagnosis methods are stored in a databank) in the form of sequences of diagnosis methods for detection and output of associated significant regions. The selection device activates one or more of the diagnosis methods stored in the databank and/or their execution sequence and checks these for deviations using the acquired data. Using the determined deviations, the selection device controls the activated diagnosis method and checks whether an automatic activation of one or more diagnosis methods by a control device (also called a CAD controller) is necessary.

The databank is provided for storage of diagnosis methods of various types and for storage of rules regarding the sequence, number, order and/or combination of the execution of the stored diagnosis methods. Depending on the scope (extent) of the databank, standard methods and/or rules are stored in this. Preliminary methods or test methods can also be stored. Moreover, the stored methods and/or rules can be updated using current data and/or information, i.e. be changed and adapted with regard to the underlying CAD algorithm. For the case that no further method and/or no further rule for the activation and execution of the diagnosis methods are stored in the execution order, sequence and/or combination, an immediately following diagnosis method is automatically selected and activated by means of the selection device. This current order and rule for execution of the diagnosis method is stored as a new rule.

Using the stored rules about sequence, number, chronological order and/or combination of the CAD algorithms of various types, these can be appropriately activated and controlled in the execution by means of the control device. Moreover, a further data interface is provided which, upon activation of one of the diagnosis methods, transfers the data relevant for the analysis (for example the image data of a lung exposure) to the appertaining diagnosis or CAD system, for example to the CAD system for lung cancer detection. The diagnosis methods can thereby be automatically self-triggered. This means that a started diagnosis method automatically starts the immediately following diagnosis method. The diagnosis methods can be controlled by means of the control device for a parallel or serial processing.

Depending on the embodiment of the device, an output unit is provided for output of the processed image data, in particular for representation of the significant region of one or more diagnosis methods. In other words: given a central output unit, the significant regions identified by means of the diagnosis methods of various types centrally output on a screen, a printer and/or stored in a storage. A fast estimation of the relevance of the output region and of the image subject situated in this region is possible given the current output of the image data. The appertaining image data of the significant regions can also be transferred (via a data transfer unit) to external users, for example to a further doctor in a networked hospital and/or to the treating primary care physician [general practitioner; family doctor].

A user interface is provided for an individual, in particular user-specific evaluation of the significant region and/or of the image subject or image subjects, The sequence, the number, the order and/or the combination of the diagnosis methods of various types to be executed are predetermined by means of the user interface. The determined significant region can also be measured and/or manipulated by means of the user interface.

An advantage achieved with the invention is that, instead of the implementation of a single diagnosis method or CAD algorithm for processing of the image data, these can be processed multiple times and using various diagnosis methods. The control of the diagnosis methods to be run thereby ensues automatically, with the sequence, the number, the order and/or the combination of the diagnosis methods to be executed being manually predetermined using a rule and/or manually. Moreover, a user can start and stop a new or further diagnosis method on the basis of the results of a predetermined diagnosis method. The rules stored for control of the diagnosis method can also be manually changed and/or changed using currently-implemented methods. The output of intermediate results of the individually executed diagnosis methods is also possible by means of the user interface.

### DESCRIPTION OF THE DRAWINGS

The single figure schematically shows a device for analysis of one or more three-dimensional digital image datasets with at least one image acquisition system and with a selection device for selection and combination of a number of stored CAD algorithms, as well as with a control unit for control of the selection CAD algorithms, in accordance with the invention.

### DESCRIPTION OF THE PREFERRED EMBODIMENTS

The figure shows a device 1 for analysis of one or more three-dimensional digital image datasets Bn. For acquisition of the digital image data Bn (for example of digital x-ray images), the device 1 has at least one data interface 2 to which are connected various image acquisition and/or image processing systems 4 and/or image archiving systems 6.

For example, a computed tomography apparatus and/or a magnetic resonance tomography are connected to the data interface 2 as acquisition units. The image acquisition and/or image processing systems 4 thereby supply current image data Bn of one or more subjects, for example a head or the torso of a patient. Data sources or data archiving units in which the current image data Bn and/or image data Bn−1 of preceding acquisition cycles are stored can also be connected.

Depending on the type and function of the underlying image acquisition and/or image processing system 4, the image data Bn, Bn−1 exhibit respective data formats. The image data Bn, Bn−1 thus are prepared (for example by means of an image processing system, for example is known as an MMT system (multimodality mapping imaging tool)) for processing by means of the device 1.

For selection of the image data Bn, Bn−1 provided for an analysis, these can be linked with further information I which, for example, are contained in the form of a header in an associated data message 8. The device 1 has a data processing unit 10 for subsequent merging of all image data Bn, Bn−1 of various subjects relevant for an analysis, and thus forming a data aggregation. For this purpose, the image data Bn, Bn−1 of the various subjects (such as the head, the limbs, the torso and/or of the entire body) prepared by means of the data interface 2 are supplied to the data processing unit 10, for example in the form of an image dataset.

A number of available diagnosis methods CAD1 through CADm of various types are mutually processed multiple times and analyzed via a selection device 12 (also called a rules engine). At least one associated significant region is sought within the relevant image data Bn, Bn−1 by means of one of the activated diagnosis methods CAD1 through CADm, and this associated significant region is identified and, if applicable, output.

The information underlying the image data Bn, Bn−1 to be processed, in particular the underlying processing rules, are compared with the diagnosis methods CAD1 through CADm (stored, for example, in a data storage 14) and checked for a deviation and/or monitored for an automatic activation of one of the diagnosis methods CAD1 through CADm (also called CAD algorithms). All rules R1 through Rz regarding the sequence, the number, the combination and/or the order of the execution (and thus regarding the activation of the diagnosis methods CAD1 through CADm of various types) are additionally stored in the data storage 14.

Moreover, the device 1 has a CAD controller 16 for control of the activated diagnosis methods CAD1 through CADm. For this purpose, a CAD controller 16 is connected via a further data interface 18 with a number of associated diagnosis systems D1 through Dm. For example, conventional diagnosis systems for detection of various types of cancers (such as, for example, for detection of lung, colorectal, liver, bone and/or breast cancer) are provided as a diagnosis system D1 through Dm.

The results of the executed diagnosis methods CAD1 through CADm are supplied to an output unit 20 via the data interface 18 and the CAD controller 16. The number, the combination and/or the order of the diagnosis methods CAD1 through CADm as well as the type and/or the extent of the output of the results of the executed diagnosis methods CAD1 through CADm can be adjusted and/or changed via a user interface 22.

Depending on the utilization of the device 1, for example as a device accessible for a number of users, this can be a user identification unit 24 for authentication and authorization of a user B.

In the operation of the device 1, the relevant CAD algorithms or diagnosis methods CAD1 through CADm are selected with regard to their sequence, order and/or combination by means of the selection device 12 using the determined image data Bn, Bn−b 1, the information I and the rules R1 through Rz. The selected and, if applicable, activated diagnosis methods CAD1 through CADm are correspondingly controlled in terms of their execution by means of the CAD controller 16 with regard to the adjustment of parameters. The selected CAD algorithms CAD1 through CADm to be executed are thus automatically activated and/or deactivated by means of the CAD controller 16. An activated diagnosis method CAD 1 can thereby automatically activate the immediately following diagnosis method or methods CAD2 through CADm. The diagnosis methods CAD1 through CADm can also process the same image data Bn, Bn−1 in parallel. In other words: an activated diagnosis method CAD1 triggers the immediately following diagnosis methods CAD2 through CADm according to the rules R1 through Rz. The workflow of the diagnosis methods CAD 1 through CADm to be executed thus can be arbitrarily stopped and/or restarted via the user interface 22 during or after an executed diagnosis method CAD1 through CADm. Intermediate results thus can be output.

For the case of the automatic activation of one of the diagnosis methods CAD1 through CADm, the appertaining diagnosis method CAD1 through CADm is activated by means of the control device 16 by the relevant image data Bn, Bn−1 and the control signals Si for controlling the associated diagnosis methods CAD1 through CADm being supplied to the associated diagnosis system D1 through Dm.

Moreover, given the output of the results of the CAD algorithms the significant region (in particular its image subject) to be output via the user interface 22 can be adjusted with regard to the resolution, size and/or the emphasis. The image data Bn, Bn−1 can also themselves be adjusted and/or manipulated via the user interface 22.

Via the use of the device 1 in the medical field for support of the doctor in the diagnosis, it is possible to process the acquired image data Bn, Bn−1 using a number of diagnosis methods CAD1 through CADm of various types. The diagnosis methods CAD1 through CADm can be executed in an arbitrarily predetermined order and/or a combination. For example, given an already-identified skin cancer those methods (for example the diagnosis method CADm+1 for detection of bone cancer) that are linked with the already-activated and/or executed CAD algorithm CADm for detection of the skin cancer can be provided as the subsequent CAD algorithm. The order and/or combination of the diagnosis methods CADm−1, CADm, CADm+1 can be determined by the probability of the successive and/or simultaneous occurrence of altered image data Bn, Bn−1 for the appertaining cancer types. Alternatively or additionally, the sequence, the order and/or the combination of the diagnosis methods CADm−1, CADm, CADm+1 to be executed can be predetermined by the determined variation and/or the determined size, in particular the dimension of image data subjects. For example, the type and/or the stage of the growth of cancer cells which are represented by the image data Bn, Bn+1 are taken into account. Multiple examinations of the patient can be safely avoided by such a combination of a number of diagnosis methods CADm to be executed.

Although modifications and changes may be suggested by those skilled in the art, it is the intention of the inventors to embody within the patent warranted hereon all changes and modifications as reasonably and properly come within the scope of their contribution to the art.

We claim as our invention:

1. A method for analyzing at least one three-dimensional digital medical image dataset, comprising the steps of:
obtaining digital medical image data from a number of subjects;
merging said image data from the respective subjects to obtain a three-dimensional digital image dataset;
electronically analyzing said three-dimensional digital image dataset multiple times with regard to a number of medical electronic diagnosis methods to identify at least one significant anatomical region, applicable for diagnosis by at least one of said electronic medical diagnosis methods; and
making data corresponding to said at least one significant region, from said three-dimensional digital image dataset, available as an output.

2. A method as claimed in claim 1 comprising making said data representing said at least one significant region available for automatically electronically conducting the diagnosis method that caused said at least one significant region to be identified.

3. A method as claimed in claim 1 comprising analyzing said three-dimensional digital image dataset with a predetermined arrangement selected from the group consisting of a designated sequence, a chronological order, and a combination, of said number of electronic diagnosis methods.

4. A method as claimed in claim 1 comprising identifying multiple significant regions respectively associated with different ones of said number of electronic medical diagnosis methods, and making data respectively representing said multiple significant regions available in said output, and respectively implementing the electronic diagnosis method, that caused each of said multiple significant regions to be identified, on the respective significant regions.

5. A method as claimed in claim 4 comprising, after identifying a first of said multiple significant regions, automatically activating a sequence of additional ones of said number of electronic medical diagnosis methods for analyzing said three-dimensional digital image dataset.

6. A method as claimed in claim 5 comprising automatically activating execution of a further sequence of further ones of said electronic medical diagnosis methods.

7. A method as claimed in claim 6 comprising manually activating said further sequence.

8. A method as claimed in claim 5 comprising manually activating said sequence.

9. A method as claimed in claim 6 comprising executing said sequence and said further sequence in an order selected from the group consisting of chronologically, in parallel, and serially.

10. A method as claimed in claim 1 comprising segmenting and measuring said at least one significant region.

11. A method as claimed in claim 1 comprising, in said output, emphasizing said at least one significant region by an emphasis technique selected from the group consisting of marking, coloring, and enlarging.

12. A method as claimed in claim 1 wherein the step of analyzing said three-dimensional image dataset comprises analyzing said three-dimensional image dataset to search for an image subject within said at least one significant region.

13. A method as claimed in claim 12 comprising selecting said subject from the group consisting of volume, geometrical arrangement, shape, contour, and center of mass.

14. A method as claimed in claim 1 comprising obtaining said image data from different regions of a single examination subject.

15. A device for analyzing at least one three-dimensional digital medical image dataset, comprising:
data sources for obtaining digital medical image data from a number of subjects;
a processing for merging said image data from the respective subjects to obtain a three-dimensional digital image dataset;
a selection unit for electronically analyzing said three-dimensional digital image dataset multiple times with regard to a number of medical electronic diagnosis methods to identify at least one significant anatomical region, applicable for diagnosis by at least one of said electronic medical diagnosis methods; and
an output unit, connected to said selection unit, making data corresponding to said at least one significant region, from said three-dimensional digital image dataset, available as an output.

16. A device as claimed in claim 15 wherein said selection unit analyzes said three-dimensional digital image dataset with a predetermined arrangement selected from the group consisting of a designated sequence, a chronological order, and a combination, of said number of electronic diagnosis methods.

17. A device as claimed in claim 15 comprising a plurality of medical diagnosis systems, and wherein said output unit make said data representing said at least one significant region available to at lease one of said medical diagnosis systems for automatically electronically conducting the diagnosis method that caused said at least one significant region to be identified.

18. A storage medium encoded with computer-readable data, loadable into a computerized selection unit for analyzing digital medical image data obtained from a number of subjects and merged into at least one three-dimensional digital medical image dataset, by causing said selection unit to:
electronically analyze said three-dimensional digital image dataset multiple times with regard to a number of medical electronic diagnosis methods to identify at least one significant anatomical region, applicable for diagnosis by at least one of said electronic medical diagnosis methods; and
make data corresponding to said at least one significant region, from said three-dimensional digital image dataset, available as an output.
